(19) United States
(12) Patent Application Publication
(10) Pub. No.: US 2026/0016657 A1
(43) Pub. Date: Jan. 15, 2026

(54) Reflection Drive Assembly and Magnet Assembling Method Thereof

(71) Applicant: NINGBO SUNNY OPOTECH CO., LTD., Ningbo City (CN)

(72) Inventors: Kuanzhi CHANGTIAN, Ningbo City (CN); Lifeng YAO, Ningbo City (CN); Wuyan TIANZHONG, Ningbo City (CN); Junlong ZHU, Ningbo City (CN); Xinyu SONG, Ningbo City (CN); Xuepeng FU, Ningbo City (CN)

(21) Appl. No.: 18/928,215

(22) Filed: Oct. 28, 2024

(30) Foreign Application Priority Data
Jun. 17, 2024 (CN) 202410781454.0

(51) Int. Cl. G02B 7/182

(52) U.S. Cl. CPC G02B 7/1827

(57) ABSTRACT

A reflection drive assembly includes a reflection base, a carrier rotatably disposed on the reflection base for carrying a reflection element which is arranged to reflect light propagating in a direction parallel to a first axis to propagate in a direction parallel to a second axis; a reflection drive part including a second rotation magnet and a second rotation coil arranged opposite to each other for driving the carrier to rotate with respect to the reflection base around a third axis which is perpendicular to the first axis and the second axis; and a rotation position sensing part including a first sensing magnet and a first rotation sensing element arranged to detect a rotation angle of the carrier around the third axis, wherein the first rotation sensing element is arranged to simultaneously sense magnetic fields of the first sensing magnet and the second rotation magnet.

### CROSS REFERENCE OF RELATED APPLICATION

This application is a non-provisional application that claims priority under 35U.S.C. § 119 to China application number CN202410781454.0, filing date Jun. 17, 2024, wherein the entire content of which is expressly incorporated herein by reference.

### BACKGROUND OF THE PRESENT INVENTION

### Field of Invention

The present invention relates to the technical field of camera modules, and more particular to a reflection drive assembly and magnet assembling method thereof.

### Description of Related Arts

A camera module with a telephoto camera function needs to have a longer focal length to obtain a clear image of a subject at a longer distance. However, having a longer focal length means that the camera module has a longer length. Therefore, at least one reflection module that can reflect light can be set in the camera module to fold the optical path of the camera module, thereby avoiding the camera module being too long.

The reflection module adopts a reflection element to fold the light path, and a corresponding reflection drive component is provided to adjust the position of the reflection element to adjust the light path, thereby further improving the imaging function of the camera module. In order to achieve closed-loop control of the reflection module, it is necessary to sense the position of the reflection element.

### SUMMARY OF THE PRESENT INVENTION

An object of the present application is to provide a reflection drive assembly capable of sensing the position of a reflection element to achieve closed-loop control.

Another object of the present application is to provide a magnet assembling method of a reflection drive assembly.

In order to achieve one of the purposes of the present application, the technical solution adopted in the present application is a reflection drive assembly which comprises:
a reflection base;
a carrier which is rotatably disposed on the reflection base for carrying a reflection element, wherein the reflection element is arranged to reflect light propagating in a direction parallel to a first axis to propagate in a direction parallel to a second axis;
a reflection drive part comprising a second rotation magnet and a second rotation coil arranged opposite to each other, wherein the second rotation magnet and the second rotation coil are arranged to cooperate to drive the carrier to rotate with respect to the reflection base around a third axis, wherein the third axis is perpendicular to the first axis and the second axis; and
a rotation position sensing part comprising a first sensing magnet and a first rotation sensing element arranged to detect a rotation angle of the carrier around the third axis, wherein the first sensing magnet and the second rotation magnet are arranged opposite to each other in a direction perpendicular to the third axis, wherein the first rotation sensing element is arranged to simultaneously sense magnetic fields of the first sensing magnet and the second rotation magnet.

In some embodiments, a projection of the first rotation sensing element along a perpendicular direction from a side thereof facing the second rotation magnet overlaps with the first sensing magnet and the second rotation magnet.

In some embodiments, the second rotation magnet and the second rotation coil are arranged opposite to each other in a direction parallel to the second axis, the first sensing magnet and the second rotation magnet are arranged opposite to each other in a direction parallel to the first axis, and the first rotation sensing element is arranged opposite to both of the first sensing magnet and the second rotation magnet in a direction parallel to the second axis.

In some embodiments, when projected along a direction parallel to the second axis, a projection of the second rotation magnet and a projection of the second rotation coil both overlap with the first axis, the first rotation sensing element is arranged on one side of the second rotation coil along a direction parallel to the first axis, and the first sensing magnet is arranged on one side of the second rotation magnet along a direction parallel to the first axis.

In some embodiments, the first rotation sensing element is disposed on an outer side of the second rotation coil.

In some embodiments, the reflection drive part also comprises a first rotation magnet and a first rotation coil, the first rotation magnet and the first rotation coil are arranged to cooperate to drive the carrier to rotate around the first axis with respect to the reflection base, the first rotation coil and the second rotation coil are located on a same side of the reflection drive part in a direction perpendicular to the third axis, and the first rotation sensing element is arranged on an outer side of the first rotation coil.

In some embodiments, magnetic poles of the first sensing magnet and the second rotation magnet facing each other are opposite.

In some embodiments, the reflection drive assembly further comprises a spacer plate disposed between the first sensing magnet and the second rotation magnet.

In some embodiments, a side of the first sensing magnet away from the second rotation magnet is inclined toward a direction approaching or away from the first rotation sensing element.

In some embodiments, an inclination angle of the first sensing magnet is not greater than 45°.

In some embodiments, an extension distance of a side of the first sensing magnet facing the first rotation sensing element and away from the second rotation magnet along a direction perpendicular to the third axis is not more than 1.2 mm, and an extension distance of a side of the first sensing magnet facing the second rotation magnet along a direction perpendicular to the third axis is not less than 0.4 mm.

In some embodiments, along a direction in which the first sensing magnet and the second rotation magnet are arranged with respect to each other, the first sensing magnet is closer to the first rotation sensing element than the second rotation magnet.

In some embodiments, the carrier is provided with a first sensing magnet groove, wherein a first inclined limit surface and a second inclined limit surface which are arranged perpendicular to each other are arranged around the first sensing magnet groove for abutting against two adjacent side surfaces of the first sensing magnet, so as to inclinedly install the first sensing magnet in the first sensing magnet groove.

In some embodiments, the first sensing magnet and the second rotation magnet are mounted on the carrier, and a reflection magnetic conductive sheet is disposed on the carrier, wherein the reflection magnetic conductive sheet, which is arranged at a position avoiding the first sensing magnet, is disposed opposite to the second rotation magnet.

In some embodiments, the rotation position sensing part further comprises a second rotation sensing element and a second sensing magnet which are arranged opposite to each other to cooperate for detecting a rotation angle of the carrier around the first axis.

In order to achieve one of the objectives of the present application, the technical solution adopted in the present application provide a magnet assembling method for any one of the above mentioned reflection drive assembly, wherein the method comprises the following steps: A, providing a carrier, a second rotation magnet for driving the carrier to rotate around a third axis, and a first sensing magnet for detecting a rotation angle of the carrier around the third axis; B, installing the first sensing magnet at a side of the carrier; and C, installing the second rotation magnet on the carrier in a manner that the second rotation magnet and the first sensing magnet are arranged with respect to each other in a direction perpendicular to the third axis.

In some embodiments, a step D is provided between the step B and the step C: providing two first rotation magnets for driving the carrier to rotate around a first axis perpendicular to the third axis, installing the two first rotation magnets on the carrier at intervals, and installing the two first rotation magnets on a same side of the carrier as the first sensing magnet, so as to allow the second rotation magnet to be installed and positioned between the two first rotation magnets in the step C.

In some embodiments, a magnetic pole of the second rotation magnet facing the first sensing magnet is the same as a magnetic pole of each of the first rotation magnets on two sides facing the second rotation magnet, and a magnetic pole of the second rotation magnet facing away from the first sensing magnet is opposite to a magnetic pole of each the first rotation magnets on two sides facing the second rotation magnet.

In some embodiments, a side of the carrier is recessed inward to form a first sensing magnet groove and a rotation magnet groove, the first sensing magnet is bonded into the first sensing magnet groove, and the first rotation magnets and the second rotation magnet are bonded into the rotation magnet groove.

In some embodiments, in the step D, the two first rotation magnets are successively inserted into the rotation magnet groove along a direction parallel to the first axis, and in the step C, the second rotation magnet is inserted into the rotation magnet groove along a direction parallel to the first axis

Compared with the prior art, the beneficial effect of the present application is that the first sensing magnet and the first rotation sensing element cooperate to detect the rotation angle of the carrier around the third axis, and can accurately sense the position of the carrier rotating around the third axis, thereby sensing the position of the reflection element, and then cooperate with the reflection drive part to realize closed-loop control of the entire reflection module.

### BRIEF DESCRIPTION OF THE DRAWINGS

FIG. 1 is a sectional view of a camera module in some embodiments of the present application.

FIG. 2 is an exploded view of the camera module in some embodiments of the present application.

FIGS. 3A and 3B are exploded views of a reflection drive assembly in some embodiments of the present application.

FIG. 4 is a partial view of the reflection drive assembly in some embodiments of the present application.

FIG. 5 is a sectional view of a reflection assembly in some embodiments of the present application.

FIG. 6 is another partial view of the reflection drive assembly in some embodiments of the present application.

FIG. 7 is another partial view of the reflection drive assembly in some embodiments of the present application.

FIG. 8 is a schematic view of a lens assembly in some embodiments of the present application.

FIG. 9 is partial enlarged view of a structure I in FIG. 8.

FIG. 10 is an exploded view of a part of the lens module in some embodiments of the present application.

### DETAILED DESCRIPTION OF THE PREFERRED EMBODIMENT

Below, the present application is further described in conjunction with specific implementation methods. It should be noted that, under the premise of no conflict, the various embodiments or technical features described below can be arbitrarily combined to form new embodiments.

In the description of the present application, it should be noted that directional words, such as the terms “center”, “lateral”, “longitudinal”, “length”, “width”, “thickness”, “up”, “down”, “front”, “back”, “left”, “right”, “vertical”, “horizontal”, “top”, “bottom”, “inside”, “outside”, “clockwise”, “counterclockwise”, etc., indicating directions and positional relationships are based on the directions or positional relationships shown in the accompanying drawings, and are only for the convenience of describing the present application and simplifying the description, and do not indicate or imply that the device or element referred to must have a specific direction, be constructed and operated in a specific direction, and cannot be understood as limiting the specific scope of protection of the present application.

It should be noted that the terms “first”, “second”, etc. in the description and claims of the present application are used to distinguish similar objects, and are not necessarily used to describe a specific order or sequence.

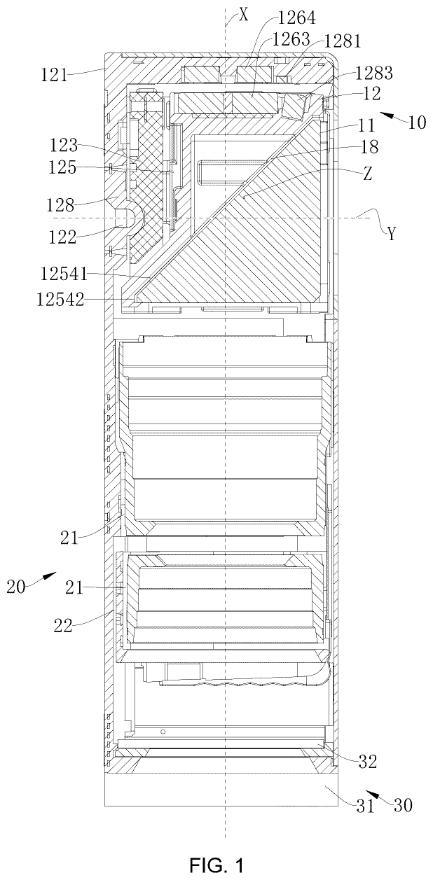

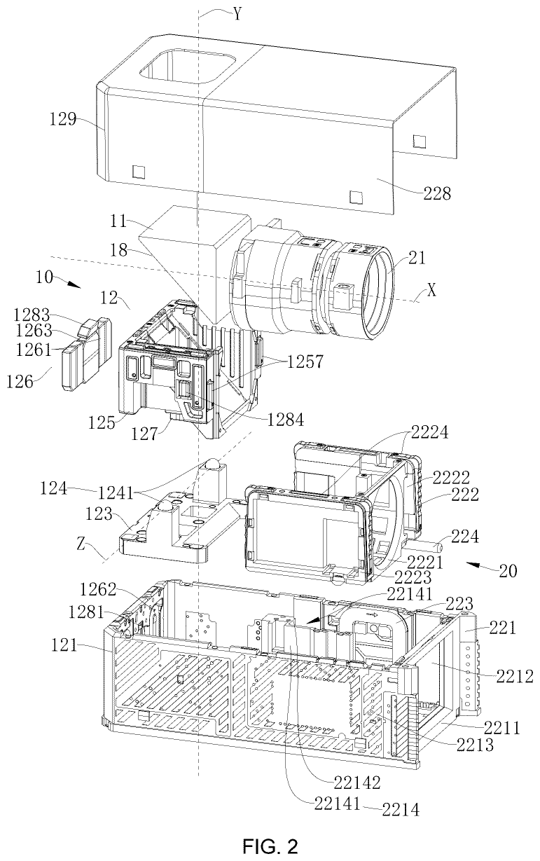

As shown in FIGS. 1 and 2, the present application provides a camera module which comprises a reflection assembly 10, a lens assembly 20 and an image assembly 30, wherein the reflection assembly 10 is used to reflect light propagating in a direction parallel to a first axis Y to propagate in a direction parallel to a second axis X, and the first axis Y and the second axis X are arranged to intersect. The lens assembly 20 is positioned on the light reflection path of the reflection assembly 10 for converging light, the image assembly 30 is positioned on the path of the imaging light emitted by the lens assembly 20 for receiving the imaging light emitted by the lens assembly 20 for imaging.

In some embodiments, the direction of the second axis X is generally the length direction of the camera module, and the reflection assembly 10, the lens assembly 20 and the image assembly 30 are arranged in sequence along the direction of the second axis X. The setting of the reflection assembly 10 can receive the incident light in the direction of the first axis Y and reflect it to the direction of the second axis X, so as to reduce the size of the camera module in the direction of the second axis X, that is, the length direction of the camera module. Further, the direction of the first axis Y is generally the height direction of the camera module. In other words, the first axis Y and the second axis X are perpendicular to each other. In other words, the reflection assembly 10 is suitable for reflecting the incident light at 90° before emitting. In other embodiments, the first axis Y and the second axis X can also be at an angle of other angles other than 90° in space. As a supplement, the first axis Y and the second axis X in the present application can be coplanar or skew.

Furthermore, for the convenience of description, the present application also defines a third axis Z, which is perpendicular to the first axis Y and the second axis X. It is worth mentioning that in the present application, the situation where the two axes are perpendicular to each other may comprise the following two types: one is that the two axes intersect in the same plane, and the intersection angle is a right angle, forming a traditional vertical relationship; the other is that the two axes are located in different planes, although they do not intersect, but their respective direction vectors are perpendicular to each other, forming a spatial vertical relationship. In other words, the vertical relationship between any two axes of the first axis Y, the second axis X and the third axis Z can be intersecting or spatial. When they intersect, the intersection angle is a right angle, forming a traditional vertical relationship; when they do not intersect, their respective direction vectors are perpendicular to each other, forming a spatial vertical relationship. In an example, as shown in FIG. 1, the first axis Y and the third axis Z do not intersect each other, the direction vector of the first axis Y and the direction vector of the third axis Z are perpendicular to each other, and the first axis Y and the third axis Z are in a spatially perpendicular relationship with each other; further, the second axis X and the third axis Z do not intersect each other, the direction vector of the second axis X and the direction vector of the third axis Z are perpendicular to each other, and the second axis X and the third axis Z are in a spatially perpendicular relationship with each other.

In some embodiments, the reflection assembly 10 comprises a reflection element 11 and a reflection drive assembly 12. The reflection element 11 is suitable for reflecting light propagating in a direction parallel to the first axis Y to propagate in a direction parallel to the second axis X, and the second axis X intersects the first axis Y. The reflection drive assembly 12 is used to drive the reflection element 11 to achieve functions such as optical image stabilization and camera angle adjustment. More specifically, the reflection drive assembly 12 is suitable for driving the reflection element 11 to rotate along the first axis Y and the third axis Z to achieve multi-dimensional adjustment.

In some embodiments, the reflection element 11 is specifically a prism or a mirror. The reflection element 11 comprises at least one light reflecting surface 18 for turning light. The light reflecting surface 18 is an inclined surface. The carrier 125 is provided with at least an inclined mounting surface 12541 corresponding to the light reflecting surface 18. The reflection element 11 is fixed on the carrier 125 to synchronously follow the movement of the carrier 125. Further, a supporting plane 12542 is provided on the side of the inclined mounting surface 12541 close to the carrier base 12511 to correspond to an edge of the reflection element 11 close to the carrier base 12511. Preferably, before assembling the reflection element 11, the rotation magnet, the sensing magnet and other components to the carrier 125, the supporting plane 12542 is pre-processed with laser engraving to reduce its reflection of light.

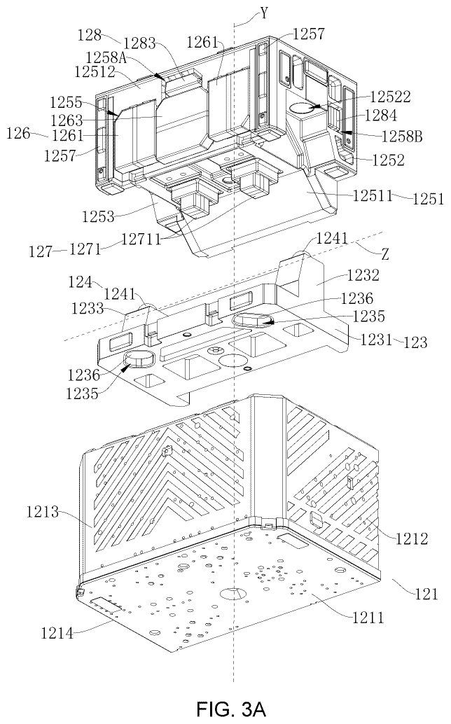

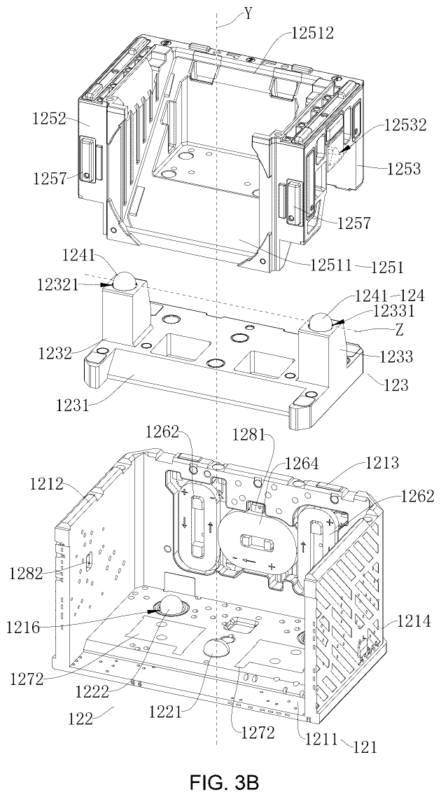

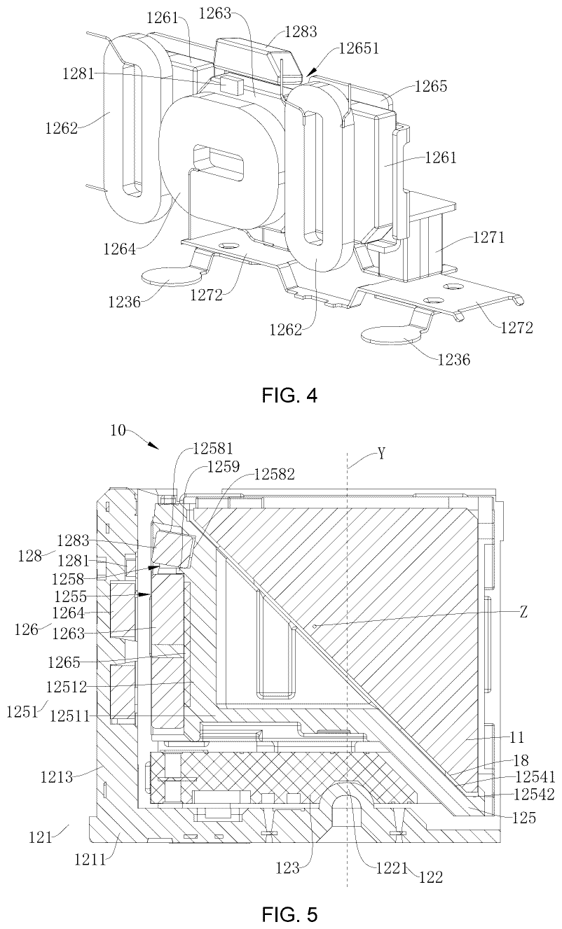

In some embodiments, referring to FIG. 3A, FIG. 3B, and FIG. 4, the reflection drive assembly 12 comprises a reflection base 121, a carrier 125, a reflection drive part 126, a rotation position sensing part 128, and a reflection cover 129, wherein the reflection base 121 serves as a support structure of the entire reflection drive assembly 12, and is used to provide a stable installation platform for other components in the reflection drive assembly 12; the reflection cover 129 is installed on the reflection base 121, and cooperates with the reflection base 121 to form a relatively sealed installation space; the carrier 125 is movably arranged on the reflection base 121 and is suitable for carrying the reflection element 11, so that the movement of the reflection element 11 with respect to the reflection base 121 can be realized by the movement of the carrier 125 with respect to the reflection base 121; the reflection drive part 126 is suitable for driving the carrier 125 to move with respect to the reflection base 121; the rotation position sensing part 128 is used to sense the position of the carrier 125 and the reflection element 11 thereon with respect to the reflection base 121, so that it can cooperate with the reflection drive part 126 to realize closed-loop control of the position of the reflection element 11.

In some embodiments, the carrier 125 is rotatably disposed on the reflection base 121, and the reflection drive part 126 is adapted to drive the carrier 125 to rotate with respect to the reflection base 121 around the first axis Y and the third axis Z which is perpendicular to the first axis Y and the second axis X. Correspondingly, the rotation position sensing part 128 comprises a first sensing magnet 1283 and a first rotation sensing element 1281 for detecting the rotation angle of the carrier 125 around the third axis Z, and a second sensing magnet 1284 and a second rotation sensing element 1282 for detecting the rotation angle of the carrier 125 around the first axis Y.

In some embodiments, the reflection base 121 comprises a reflection substrate 1211 and a reflection base side portion arranged around the reflection substrate 1211. Specifically, the reflection base side portion comprises a first reflection base side portion 1212, a second reflection base side portion 1213, and a third reflection base side portion 1214 arranged in sequence, the first reflection base side portion 1212 and the third reflection base side portion 1214 are arranged opposite to each other along the third axis Z direction, the second reflection base side portion 1213 connects the first reflection base side portion 1212 to the third reflection base side portion 1214, and is arranged opposite to the lens assembly 20 along the direction of the second axis X. Correspondingly, the carrier 125 comprises a carrier body 1251, a first carrier side portion 1252 and a second carrier side portion 1253. The first carrier side portion 1252 and the second carrier side portion 1253 are respectively arranged on two opposite sides of the carrier body 1251 along the third axis Z. Further, the carrier body 1251 may comprise a carrier base 12511 and a third carrier side portion 12512. The carrier base 12511 is arranged above the reflection base 1211, and the third carrier side portion 12512 is arranged opposite to the second reflection base side portion 1213. The three carrier side portions are arranged around the carrier base 12511 to form a reflection element accommodating cavity suitable for installing the reflection element 11.

In some embodiments, the reflection drive assembly 12 further comprises a support structure which is disposed between the carrier 125 and the reflection base 121 and is used to achieve mobility of the carrier 125 with respect to the reflection base 121.

In some embodiments, the support structure specifically comprises a frame 123, a first supporting portion 122 and a second supporting portion 124. The frame 123 is disposed on the reflection base 121 and is suitable for carrying the carrier 125. The frame 123 and the reflection base 121 are connected via the first supporting portion 122, so that the frame 123 can rotate around the first axis Y with respect to the reflection base 121. The carrier 125 and the frame 123 are connected via the second supporting portion 124, so that the carrier 125 can rotate around the third axis Z with respect to the frame 123, thereby realizing that the carrier 125 can rotate around the first axis Y and the third axis Z with respect to the reflection base 121.

In some embodiments, the frame 123 specifically comprises a frame body 1231, a first frame side portion 1232, and a second frame side portion 1233, wherein the first frame side portion 1232 and the second frame side portion 1233 are arranged at two opposite sides of the frame body 1231 along the third axis Z. The frame body 1231 is rotatably connected to the reflection substrate 1211 via the first support portion 122 to support the frame 123, and the frame 123 is able to rotate with respect to the reflection substrate 121 around the first axis Y; the first carrier side portion 1252 of the carrier 125 is rotatably connected to the first frame side portion 1232 via the second support portion 124, and the second carrier side portion 1253 of the carrier 125 is rotatably connected to the second frame side portion 1233 of the frame 123 via the second support portion 124 to support the carrier 125 on the frame 123 and enable the carrier 125 to rotate with respect to the frame 123 around the third axis Z.

In some embodiments, the first support portion 122 comprises a shaft support 1221, which is fixedly disposed on one of the reflection substrate 1211 of the reflection base 121 and the frame body 1231 of the frame 123 by insert injection molding or integrated molding. A shaft positioning groove that matches with the shaft support 1221 is disposed on the other of the reflection substrate 1211 and the frame body 1231. The shaft support 1221 and the shaft positioning groove are disposed along the first axis Y, or in other words, the first axis Y passes through the shaft support 1221 and the shaft positioning groove, so that the frame 123 can only rotate around the first axis Y with respect to the reflection base 121. Furthermore, the first support portion 122 also comprises one or more auxiliary balls 1222, each of which is arranged between the auxiliary upper groove 1235 of the frame body 1231 and the auxiliary lower groove 1216 of the reflection base 1211, and is used to reduce the friction resistance during the rotation of the frame 123, and cooperate with the shaft support 1221 to provide a supporting plane for the frame 123 to stably support the frame 123.

In some embodiments, the second support portion 124 comprises two shaft balls 1241, the frame 123 is provided with two shaft lower grooves, respectively recorded as a first shaft lower groove 12321 and a second shaft lower groove 12331, the carrier 125 is provided with two shaft upper grooves, respectively recorded as a first shaft upper groove 12522 and a second shaft upper groove 12532, the two shaft lower grooves are arranged on two opposite sides of the frame 123 along a direction parallel to the third axis Z, the two shaft upper grooves are respectively arranged opposite to the two shaft lower grooves, the second support portion 124 comprises two shaft balls 1241 arranged between each shaft lower groove and the corresponding shaft upper groove, the third axis Z passes through the two shaft balls 1241, and the shaft balls 1241 cooperate with the shaft upper groove and the shaft lower groove to guide the carrier 125 to rotate around the third axis Z with respect to the frame 123.

In some embodiments, the assembling steps of the reflection assembly 10 are as follows: after providing grease on each auxiliary ball 1222, each auxiliary ball 1222 is placed in the auxiliary lower groove 1216, and the auxiliary upper groove 1235 is aligned with the auxiliary ball 1222 so that the frame 123 is supported on the reflection base 121; after providing grease on each shaft ball 1241, each shaft ball 1241 is placed in the shaft lower groove, and the shaft upper groove is aligned with the corresponding shaft ball 1241 so that the carrier 125 is supported on the frame 123. Further, according to whether the reflection cover 129 and the lens cover 228 are split or integrated, the reflection cover 129 can also be connected to the reflection base 121 in the last step of assembling the reflection assembly 10, or the last step of assembling the entire camera module, so as to further fix the carrier 125. The grease can be industrial grease, such as G501 grease. The provision of grease can effectively reduce the friction between the ball and the shaft upper groove, the shaft lower groove, the auxiliary upper groove 1234, and the auxiliary lower groove 1216.

In some embodiments, the reflection drive assembly 12 also comprises a reflection magnetic attraction part 127, and the reflection magnetic attraction part 127 comprises a first reflection magnetic component 1271 disposed on the carrier 125 and a second reflection magnetic component 1272 disposed on the reflection base 121, and the two are magnetically attracted to each other, so that the carrier 125 can be magnetically attracted to the reflection base 121 through the support structure, or in other words, the carrier 125 and the reflection base 121 clamp the support structure therebetween. The first reflection magnetic component 1271 and the second reflection magnetic component 1272 are preferably disposed on the reflection base 1211 and the carrier base 12511, and one of them is a magnet and the other is a magnetic conductive material suitable for being attracted by the magnet, such as a magnet or a yoke suitable for being attracted by the magnet. In a specific embodiment, the first reflection magnetic component 1271 comprises a magnetically attracting magnet 12711.

In some embodiments, an auxiliary ball supporting metal part 1236 is provided on the frame 123 and/or the reflecting base 121. The auxiliary ball supporting metal part 1236 is embedded in the frame 123 or the reflecting base 121 through an insert injection molding process, and is exposed as the bottom of the auxiliary upper groove 1235 or the auxiliary lower groove 1216, which can enhance the structure while making the auxiliary groove have a harder bottom to reliably support the ball.

In some embodiments, as shown in FIG. 5, the auxiliary ball bearing support metal member 1236 can be fixedly connected to the reflection magnetic attraction part 127 to increase the structural strength. Furthermore, the auxiliary ball bearing support metal member 1236 can be fixedly connected to the first reflection magnetic member 1271 or the second reflection magnetic member 1272, and then embedded in the frame 123 or the reflection base 121 through an insert injection molding process, which is beneficial to reduce the number of material strip connections, simplify the process flow, and save the space reserved for setting the material strip inside the mold.

In some embodiments, the reflection drive part 126 comprises a first rotation magnet 1261 and a first rotation coil 1262 suitable for driving the carrier 125 to rotate around the first axis Y, and a second rotation magnet 1263 and a second rotation coil 1264 suitable for driving the carrier 125 to rotate around the third axis Z, and the rotation magnet and the corresponding rotation coil are arranged with respect to each other along the second axis X. The carrier 125 can rotate around the first axis Y and the third axis Z with respect to the reflection base 121, thereby realizing the anti-shake (OIS) function. Specifically, the rotation coil is centrally arranged on the second reflection base side 1213 of the reflection base 121, and the rotation magnet is centrally arranged on the third carrier side portion 12512 of the carrier 125. The rotation coil is arranged on the reflection base 121 for electrical connection. Specifically, the rotation coil can be electrically connected to the rear lens assembly 20 and the image assembly 30 through a circuit board installed on the reflection base 121, or a conductive insert that is insert-molded inside the reflection base 121.

In some embodiments, a carrier buffer 1257 is disposed on the carrier 125, and the carrier buffer 1257 is made of a flexible material, such as silicone. The carrier buffer 1257 can be disposed on the carrier 125 by gluing, secondary injection molding, etc., and protrudes in at least one direction with respect to the carrier 125 to achieve buffering during the rotation of the carrier 125, thereby preventing the carrier 125 from colliding and damaging with the reflection base 121, the reflection cover 129, or the frame 123.

In some embodiments, the carrier buffers 1257 are respectively disposed on the first carrier side portion 1252 and the second carrier side portion 1253. Each carrier buffer 1257 protrudes upward in a direction parallel to the first axis Y to achieve a buffer between the carrier 125 and the reflection cover 129. In some embodiments, each carrier buffer 1257 protrudes downward in a direction parallel to the first axis Y and/or protrudes in a direction parallel to the second axis X to achieve a buffer effect between the carrier 125 and the reflection base 121.

In some embodiments, the reflection drive part 126 may also be disposed on other sides of the carrier 125. For example, the first rotation magnet 1261 and the first rotation coil 1262 may be disposed on one side of the carrier 125 parallel to the third axis Z direction; the second rotation magnet 1263 and the second rotation coil 1264 may be disposed on one side of the carrier 125 parallel to the direction of the first axis Y, for example, on the side where the carrier base 12511 is located.

In some embodiments, the first sensing magnet 1283 and the second rotation magnet 1263 are arranged opposite to each other in a direction perpendicular to the third axis Z. Combined with the above structural description of the reflection drive part 126. In some embodiments, the second rotation magnet 1263 and the second rotation coil 1264 are arranged on the side where the carrier substrate 12511 is located. Specifically, the second rotation magnet 1263 may be arranged on the carrier substrate 12511, and the second rotation coil 1264 may be arranged on the reflection substrate 1211. The first sensing magnet 1283 and the second rotation magnet 1263 are arranged opposite to each other in a direction parallel to the second axis X, and the first rotation sensing element 1281 is arranged opposite to the first sensing magnet 1283 and the second rotation magnet 1263 in a direction parallel to the first axis Y at the same time.

In another embodiment, the second rotation magnet 1263 is disposed on the third carrier side portion 12512 of the carrier 125, and the second rotation coil 1264 is disposed on the second reflection base side portion 1213 of the reflection base 121. The second rotation magnet 1263 and the second rotation coil 1264 are disposed opposite to each other along a direction parallel to the second axis X, the first sensing magnet 1283 and the second rotation magnet 1263 are disposed opposite to each other along a direction parallel to the first axis Y, and the first rotation sensing element 1281 is disposed opposite to both the first sensing magnet 1283 and the second rotation magnet 1263 along a direction parallel to the second axis X.

In some embodiments, the first rotation sensing element 1281 is suitable for simultaneously sensing the magnetic fields of the first sensing magnet 1283 and the second rotation magnet 1263 to determine the rotation angle of the carrier 125 around the third axis Z, and to perform closed-loop control on the rotation of the carrier 125 around the third axis Z. It should be understood that if the first sensing magnet 1283 is used alone, it needs to have a sufficiently large magnetization area to provide sufficient magnetic field strength, so that the second rotation magnet 1263 and the first sensing magnet 1283 can jointly generate a magnetic field provided to the first rotation sensing element 1281 for operation, so that the size of the first sensing magnet 1283 in the direction parallel to the relative arrangement of the first sensing magnet 1283 and the second rotation magnet 1263 does not need to be designed to be larger.

In some embodiments, considering that the driving current of the second rotation coil 1264 is not constant when it is working in order to meet different driving requirements, the magnetic field generated by the second rotation coil 1264 will change in real time. When the first rotation sensing element 1281 is arranged in the second rotation coil 1264, especially in the middle of the second rotation coil 1264, the changing magnetic field of the second rotation coil 1264 will interfere with the detection of the first rotation sensing element 1281. The second rotation coil 1264 and the first rotation sensing element 1281 are arranged at the second reflection base side portion 1213, and the first rotation sensing element 1281 is arranged on the outside of the second rotation coil 1264 to reduce the magnetic interference of the second rotation coil 1264 on the first rotation sensing element 1281, which is conducive to improving the accuracy of position detection.

In some embodiments, the first rotation coil 1262 is also disposed on the second reflection base side portion 1213. At this time, the first rotation coil 1262 and the second rotation coil 1264 are located on the same side of the reflection drive assembly 12 in the direction perpendicular to the third axis Z, which is conducive to reducing the magnetic interference of the rotation coil and the rotation magnet on the other sides of the carrier 125. The first rotation sensing element 1281 is disposed on the outside of the first rotation coil 1262. This reduces the magnetic interference of the first rotation coil 1262 on the first rotation sensing element 1281, which is conducive to improving the accuracy of position detection. Correspondingly, the first rotation magnet 1261 and the second rotation magnet 1263 are both disposed on the third carrier side portion 12512.

Furthermore, the second rotation magnet 1263 is set to be single, and the first rotation magnet 1261 can be set to be two, and they are respectively arranged on two opposite sides of the second rotation magnet 1263 along the direction parallel to the third axis Z. The first rotation magnet 1261 and the first rotation coil 1262 are set to be two pairs to provide a larger driving force for the frame 123 and the carrier 125 thereon, so that the frame 123 and the carrier 125 thereon can rotate smoothly around the first axis Y.

In some embodiments, in order to reduce the interference of the carrier 125 on the first rotation sensing element 1281 when rotating around the first axis Y, the projection of the first rotation sensing element 1281 and the first sensing magnet 1283 along the direction parallel to the second axis X overlaps with the first axis Y. More specifically, the length direction of the first rotation sensing element 1281 can be perpendicular to the first axis Y, for example, can be parallel to the third axis Z.

In some embodiments, when projected in a direction parallel to the second axis X, the projection of the second rotation magnet 1263 and the projection of the second rotation coil 1264 overlap with the first axis Y at the same time, the first rotation sensing element 1281 is arranged on one side of the second rotation coil 1264 in a direction parallel to the first axis Y, and the first sensing magnet 1283 is arranged on one side of the second rotation magnet 1263 in a direction parallel to the first axis Y. Specifically, the first sensing magnet 1283 is arranged above or below the second rotation magnet 1263 in a direction parallel to the first axis Y, and correspondingly, the first rotation sensing element 1281 is arranged above or below the second rotation coil 1264 in a direction parallel to the first axis Y. Therefore, when projected in a direction parallel to the second axis X, the projections of the second rotation magnet 1263, the second rotation coil 1264, the first rotation sensing element 1281, and the first sensing magnet 1283 all overlap with the first axis Y. The layout is reasonable and compact. While reducing the magnetic interference of each magnet on the other sides of the carrier 125 except the third carrier side portion 12512, it is also beneficial to reduce the interference caused by the rotation of the carrier 125 around the first axis Y on the detection of the rotation angle of the carrier 125 around the third axis Z.

In some embodiments, the first rotation sensing element 1281 is disposed above the second rotation coil 1264 along a direction parallel to the first axis Y, and correspondingly, the first sensing magnet 1283 is disposed above the second rotation magnet 1263 along a direction parallel to the first axis Y. When the carrier 125 rotates around the third axis Z, the adjacently disposed first sensing magnet 1283 and the second rotation magnet 1263 jointly provide a sensing magnetic field for the first rotation sensing element 1281, and the first rotation sensing element 1281 detects the magnetic field information of the first sensing magnet 1283 and the second rotation magnet 1263 to calculate the rotation angle of the carrier 125 around the third axis Z.

In some embodiments, the first rotation sensing element 1281 is disposed above the second rotation coil 1264 along a direction parallel to the first axis Y. The second rotation coil 1264 and the second rotation magnet 1263 are disposed on a side relatively close to the frame 123 along a direction parallel to the first axis Y, that is, on a side relatively close to the reflection substrate 1211, so as to reserve a space for installing the first rotation sensing element 1281 and the first sensing magnet 1283 above the second rotation coil 1264 and above the second rotation magnet 1263. When the first rotation magnet 1261 and the second rotation magnet 1263 are disposed on the same side of the carrier 125, that is, on the third carrier side portion 12512, the distance between the second rotation magnet 1263 and the reflection substrate 1211 is smaller than the distance between the first rotation magnet 1261 and the reflection substrate 1211.

It can be understood that in order to ensure that the first sensing magnet 1283 and the second rotation magnet 1263 can both generate a magnetic field of sufficient strength at the first rotation sensing element 1281, the projection of the first rotation sensing element 1281 along the vertical direction from a side of the first rotation sensing element 1281 facing the second rotation magnet 1263 overlaps with the first sensing magnet 1283 and the second rotation magnet 1263 at the same time. The first sensing magnet 1283 and the second rotation magnet 1263 need to be arranged adjacent to each other. As a supplement, the adjacent arrangement comprises an interval arrangement and a contact arrangement without an interval. When the first sensing magnet 1283 and the second rotation magnet 1263 are arranged at intervals, it is more conducive to the tilted installation of the first sensing magnet 1283. Specifically, when the first sensing magnet 1283 and the second rotation magnet 1263 are arranged with respect to each other in a direction parallel to the first axis Y, the first rotation sensing element 1281 is arranged with respect to the first sensing magnet 1283, the second rotation magnet 1263, and the interval area between the two magnets in a direction parallel to the second axis X. At this time, the perpendicular direction of a side of the first rotation sensing element 1281 facing the second rotation magnet 1263 is a direction parallel to the second axis X. In other words, the projection of the first rotation sensing element 1281 along the direction parallel to the second axis X overlaps with the first sensing magnet 1283 and the second rotation magnet 1263 at the same time. When the first sensing magnet 1283 and the second rotation magnet 1263 are arranged relatively to each other along the direction parallel to the second axis X, at this time, the perpendicular direction of a side of the first rotation sensing element 1281 facing the second rotation magnet 1263 is a direction parallel to the first axis Y, and the projection of the first rotation sensing element 1281 along the direction parallel to the first axis Y overlaps with the first sensing magnet 1283 and the second rotation magnet 1263 at the same time.

In some embodiments, in order to allow the first sensing magnet 1283 and the second rotation magnet 1263 to be smoothly arranged adjacent to each other in a direction perpendicular to the third axis Z, the magnetic poles of the first sensing magnet 1283 and the second rotation magnet 1263 facing each other are opposite, so as to avoid the magnetic repulsion between the two magnets affecting the precise installation of the magnets. More specifically, the magnetic poles of the two magnets in the area facing the first rotation sensing element 1281 and adjacent to each other are opposite. If the magnetic poles of the first sensing magnet 1283 and the second rotation magnet 1263 in the adjacent area are the same, the magnetic repulsion between the first sensing magnet 1283 and the second rotation magnet 1263 makes it difficult for the two to be installed close to each other, and the sensing linearity of the first rotation sensing element 1281 will also be poor.

In addition, the magnetization of a magnet refers to the rearrangement of the magnetic domains inside the magnet by applying an external magnetic field to the magnet, so that the directions of the magnetic moments of the magnetic domains tend to be consistent. The magnetization direction is the arrangement direction of the internal magnetic domains when the magnet is magnetized, that is, the direction of the N pole (North Pole) and S pole (South Pole) of the magnet. In some embodiments, the first sensing magnet 1283 is a unipolar magnet, and the second rotation magnet 1263 is a multipolar magnet, specifically a bipolar magnet, and the magnetization direction of the first sensing magnet 1283 is not perpendicular to the magnetization direction of the second rotation magnet 1263.

In some embodiments, referring to FIG. 5, in order to prevent the first sensing magnet 1283 and the second rotation magnet 1263 from shifting closer to each other or changing the magnet postures unnecessarily due to the magnetic attraction between them, a spacer plate 1259 is provided between the first sensing magnet 1283 and the second rotation magnet 1263 to keep the first sensing magnet 1283 and the second rotation magnet 1263 spaced apart. Specifically, when the first sensing magnet 1283 and the second rotation magnet 1263 are relatively arranged on the third carrier side portion 12512 along a direction parallel to the first axis Y, the spacer plate 1259 can be arranged protruding from the carrier 125 along a direction parallel to the second axis X toward the first rotation sensing element 1281.

In some embodiments, a side of the first sensing magnet 1283 facing the first rotation sensing element 1281 is coplanar or parallel to a side of the second rotation magnet 1263 facing the first rotation sensing element 1281. Specifically, a side of the first sensing magnet 1283 facing the first rotation sensing element 1281 and a side of the second rotation magnet 1263 facing the first rotation sensing element 1281 both extend in a direction parallel to the first axis Y.

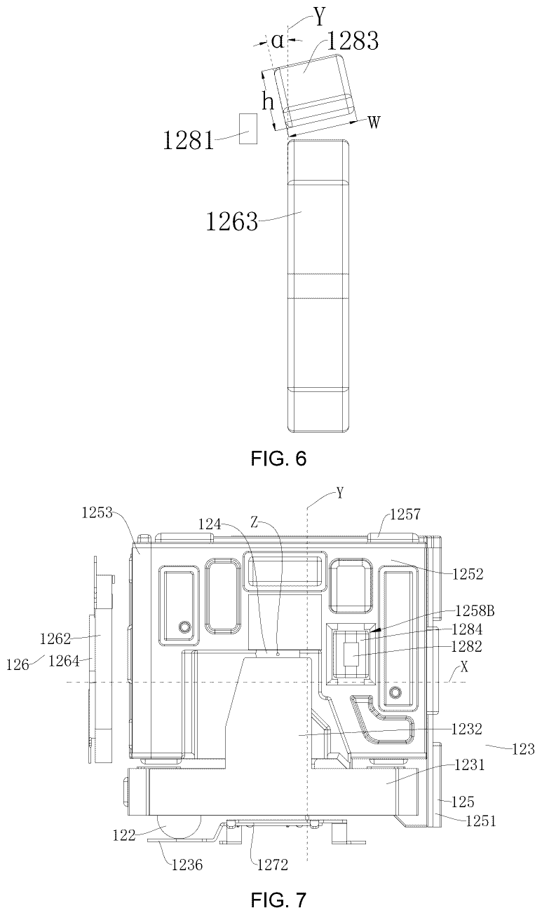

In some embodiments, referring to FIG. 5 and FIG. 6, the side of the first sensing magnet 1283 away from the second rotation magnet 1263 is tilted toward or away from the first rotation sensing element 1281. In other words, the side of the first sensing magnet 1283 facing the first rotation sensing element 1281 and away from the second rotation magnet 1263 is tilted with respect to the side of the second rotation magnet 1263 facing the first rotation sensing element 1281. Considering that the carrier 125 and the first sensing magnet 1283 thereon need to rotate around the third axis Z, the first sensing magnet 1283 is tilted with respect to the second rotation magnet 1263, which is conducive to making the sensing result of the first rotation sensing element 1281 have better symmetry during the rotation of the carrier 125, so as to calibrate the first rotation sensing element 1281. It should be pointed out that when the side of the first sensing magnet 1283 away from the second rotation magnet 1263 is inclined toward the first rotation sensing element 1281, a similar effect can be achieved as when the side of the first sensing magnet 1283 away from the second rotation magnet 1263 is inclined at the same angle toward the first rotation sensing element 1281.

Further, considering that when the first sensing magnet 1283 is tilted, the magnetic field provided to the first rotation sensing element 1281 is relatively weakened compared to the case where it is not tilted. In some embodiments, in order to balance the magnetic field strength of the first sensing magnet 1283 and the second rotation magnet 1263 at the first rotation sensing element 1281, the position of the first rotation sensing element 1281 is adjusted in a direction close to the first sensing magnet 1283.

Specifically, along the direction in which the first sensing magnet 1283 and the second rotation magnet 1263 are relatively arranged, for example, in a direction parallel to the first axis Y, the first sensing magnet 1283 is closer to the first rotation sensing element 1281 than the second rotation magnet 1263. In other words, in some embodiments, the first rotation sensing element 1281 is projected along a direction parallel to the second axis X, and the distance between the center of the projection and the first sensing magnet 1283 is smaller than the distance between the center of the projection and the second rotation magnet 1263. This also means that the first rotation sensing element 1281 is arranged farther away from the second rotation coil 1264 along the direction parallel to the first axis Y, which helps to reduce the magnetic interference of the second rotation coil 1264 on the first rotation sensing element 1281.

It should be noted that the detection of the first rotation sensing element 1281 relies on the magnetic field in the normal direction toward the first sensing magnet 1283 and the second rotation magnet 1263, and magnetic fields in other directions will interfere with the first rotation sensing element 1281. In order to ensure the accuracy of the detection result of the first rotation sensing element 1281, during the rotation of the carrier 125 around the third axis Z of the present application, the magnetic difference of the first rotation sensing element 1281 in the required direction is at least 18 millitesla/optical angle, abbreviated as 18 mT/deg.

In some embodiments, the normal direction of the first rotation sensing element 1281 facing the second rotation magnet 1263 is in the direction parallel to the second axis X. In order to more clearly describe the direction of the magnetic field, a direction parallel to the second axis X is defined as Bx, a direction parallel to the first axis Y is defined as By, and a direction parallel to the third axis Z is defined as Bz. Within the rated travel range of the carrier 125, the magnetic difference of the first rotation sensing element 1281 in the Bx direction is at least 18 mT/deg.

In order to design the inclination angle α of the first sensing magnet 1283, the present application provides the magnetic differences along the Bx direction measured when the first sensing magnet 1283 is at multiple inclination angles, as shown in Table 1.

TABLE 1
Magnetic field of the first sensing magnet at different tilt angles

| | | | | | Bx Magnetic |
|---|---|---|---|---|---|
| | Rotation | | | | deviation |
| Tilt Angle | Angle | Bz (mT) | By (mT) | Bx (mT) | (mT/deg) |
| 10° | −0.65° | −3.596161551 | 294.0902587 | −32.33193694 | 23.14507332 |
| | 0° | −3.988070877 | 302.5660439 | −3.365748267 | |
| | 0.65° | −4.260119779 | 307.9670245 | 27.8452537 | |
| 20° | −0.65° | −2.951592831 | 285.4239274 | −27.9668212 | 22.41369604 |
| | 0° | −3.153190017 | 291.4585752 | 0.289320159 | |
| | 0.65° | −3.61966797 | 294.6086344 | 30.30878849 | |
| 30° | −0.65° | −2.427152055 | 280.0650518 | −34.02603372 | 20.41468152 |
| | 0° | −2.715187147 | 285.994232 | −8.334670676 | |
| | 0.65° | −2.966720517 | 289.5682924 | 19.05213824 | |
| 45° | −0.65° | −1.886620638 | 270.6566349 | −29.89164203 | 18.05134749 |
| | 0° | −1.994888995 | 275.189279 | −6.85802053 | |
| | 0.65° | −2.320398507 | 277.9446135 | 17.04186143 | |

The parameter a in the first column is an angle of the first sensing magnet 1283 away from the second rotation magnet 1263 and tilted toward or away from the first rotation sensing element 1281; the column “Rotation Angle” is the mechanical angle of the carrier 125 rotating around the third axis Z; the three columns “Bx (mT)”, “By (mT)”, and “Bz (mT)” are the magnetic field strengths in mT in the directions of Bx, By, and Bz, respectively; the column “Bx Magnetic Difference (mT/deg)” is the magnetic difference in the Bx direction. The calculation formula for the magnetic difference is: [Bx (0.65°)-Bx (−0.65°)]/1.3/2. It can be understood that when the carrier 125 rotates around the third axis Z, the rotation angle of the carrier 125 is equivalent to the rotation angle of the light reflecting surface 18. When the rotation angle of the light reflecting surface 18 around the third axis changes from 0 to B, the reflection angle of the incident light increases by 2*B. Therefore, when calculating the magnetic difference, it is necessary to divide by 2 to realize the conversion from mechanical angle to optical angle.

It can be seen from the statistical results in Table 1 that the inclination angle α of the first sensing magnet 1283 is not greater than 45, and can be specifically 10°, 20°, 30°, or 45°.

As a supplement, when the inclination angle α of the first sensing magnet 1283 changes, the position of the first rotation sensing element 1281 can be adjusted to balance the magnetic field strength of the first sensing magnet 1283 and the second rotation magnet 1263 at the first rotation sensing element 1281. In other words, when the magnetic difference in the Bx direction of the first sensing magnet 1283 at different inclination angles is counted, the position of the first rotation sensing element 1281 is not fixed.

In some embodiments, the extension distance h of the first sensing magnet 1283 facing the first rotation sensing element 1281 and away from the second rotation magnet 1263 along the direction perpendicular to the third axis Z is not greater than 1.2 mm. In other words, when the first sensing magnet 1283 is placed horizontally with the side facing the second rotation magnet 1263, or when it is placed perpendicular to the first axis Y, the height h of the first sensing magnet 1283 is not greater than 1.2 mm. This is because the greater the height h of the first sensing magnet 1283, the greater the magnetic field strength along the direction parallel to the first axis Y/By direction, and the greater the interference to the first rotation sensing element 1281.

In some embodiments, the extension distance w of the first sensing magnet 1283 toward one side of the second rotation magnet 1263 in the direction perpendicular to the third axis Z is not less than 0.4 mm. In other words, the width w of the first sensing magnet 1283 is not less than 0.4 mm. This is because the smaller the width w of the first sensing magnet 1283, the smaller the magnetic field strength in the direction parallel to the second axis X/Bx direction. Therefore, the width w of the first sensing magnet 1283 is set to be greater than or equal to 0.4 mm to ensure that the magnetic field in the direction parallel to the second axis X/Bx direction is sufficient to support the normal operation of the first rotation sensing element 1281.

In some embodiments, the length direction of the first sensing magnet 1283 is set along a direction parallel to the third axis Z, and the length range of the first sensing magnet 1283 is not limited in this application.

In some embodiments, with reference to FIG. 4, the first sensing magnet 1283 and the second rotation magnet 1263 are mounted on the carrier 125, and a reflection magnetic conductive sheet 1265 is disposed on the carrier 125. The reflection magnetic conductive sheet 1265 is avoiding and positioned clear of the first sensing magnet 1283 and is disposed opposite to the second rotation magnet 1263. Specifically, the reflection magnetic conductive sheet 1265 is provided with a notch 12651 in the area corresponding to the inclined first sensing magnet 1283. The reflection magnetic conductive sheet 1265 can constrain the magnetic field of the second rotation magnet 1263 and enhance the magnetic field strength of the second rotation magnet 1263 facing the second rotation coil 1264. Assuming that the reflection magnetic conductive sheet 1265 is disposed with respect to the first sensing magnet 1283, a local area of the reflection magnetic conductive sheet 1265 needs to be set to the same inclination angle as the first sensing magnet 1283, which has the problem of inconvenient processing. In more detail, the reflection magnetic conductive sheet 1265 is generally embedded in the carrier 125. When the carrier 125 is injection molded, a pin can be inserted from the top of the carrier 125 along a direction parallel to the first axis Y to control the bending angle of a local area of the reflection magnetic conductive sheet 1265. After the carrier 125 is basically formed, the pin is pulled out to achieve a local tilt setting of the reflection magnetic conductive sheet 1265. However, the pin hole left on the carrier 125 will cause the reflection magnetic conductive sheet 1265 to be partially exposed, thereby causing the camera module to generate stray light.

In some embodiments, with reference to FIG. 3A and FIG. 3B, the second sensing magnet 1284 is disposed on one side of the carrier 125 along a direction parallel to the third axis Z, and the second rotation sensing element 1282 is disposed on one side of the reflection base 121 along a direction parallel to the third axis Z with respect to the second sensing magnet 1284. In other words, the second rotation sensing element 1282 and the second sensing magnet 1284 are disposed opposite to each other along a direction parallel to the third axis Z, and the second sensing magnet 1284 can be disposed in the second sensing magnet groove 1258B on the first carrier side portion 1252 or the second carrier side portion 1253, and correspondingly, the second rotation sensing element 1282 can be disposed on the first reflection base side portion 1212 or the third reflection base side portion 1214. The combination of the second sensing magnet 1284 and the second rotation sensing element 1282 and the combination of the rotation magnet and the rotation coil are disposed on different sides of the reflection module 10, which is conducive to reducing the magnetic interference between each other, so that each part can reasonably utilize the space between the carrier 125 and the reflection base 121 for layout, and maintain a compact structure. The second rotation sensing element 1282 is disposed on the reflection base 121 for easy electrical connection.

In some embodiments, as shown in FIG. 7, the second rotation sensing element 1282 and the third axis Z are disposed opposite to each other in a direction parallel to the second axis Y. In other words, when the direction of the first axis Y is the height direction of the reflection assembly 10, the second rotation sensing element 1282 and the third axis Z are disposed at the same height to reduce the magnetic field crosstalk encountered by the second rotation sensing element 1282.

In some embodiments, similar to the power supply method of the rotation coil, the first rotation sensing element 1281 and the second rotation sensing element 1282 can be electrically connected to the rear lens assembly 20 and the image assembly 30 through a circuit board mounted on the reflection base 121, or a conductive insert that is insert-molded inside the reflection base 121. The rotation sensing element can specifically be a magnetoresistive sensor, or a Hall element, or a driving chip with a magnetoresistive sensor and/or a Hall element.

In summary, in some embodiments, the carrier 125 is provided with a first sensing magnet 1283, a second sensing magnet 1284, two first rotation magnets 1261, a second rotation magnet 1263 and two magnetic attracting magnets 12711.

The present application further provides a magnet assembling method for a reflection drive assembly, which comprises the following steps: A. providing a carrier 125, a second rotation magnet 1263 suitable for driving the carrier 125 to rotate around a third axis Z, and a first sensing magnet 1283 suitable for detecting the rotation angle of the carrier 125 around the third axis Z; B. installing the first sensing magnet 1283 on one side of the carrier 125; C. installing the second rotation magnet 1263 on the carrier 125 so that the second rotation magnet 1263 and the first sensing magnet 1283 are arranged with respect to each other in a direction perpendicular to the third axis Z. In a specific embodiment, the second rotation magnet 1263 and the first sensing magnet 1283 are arranged with respect to each other in a direction parallel to the first axis Y. Since the first sensing magnet 1283 is smaller in size than other magnets, and needs to be tilted in some embodiments, it is assumed that the rotation magnet is installed first and then the first sensing magnet 1283. The position and tilt angle of the first sensing magnet 1283 are easily affected by other magnets, especially the adjacent second rotation magnet 1263, making the installation difficult. Installing the first sensing magnet 1283 first and then the rotation magnet can reduce the difficulty of assembly and facilitate the precise installation of the first sensing magnet 1283.

In some embodiments, in the step B, the first sensing magnet 1283 is installed by setting an adhesive on the side of the carrier 125 and/or the first sensing magnet 1283. Specifically, the step B may comprise the following steps: B1, one side of the carrier 125 is recessed inward to form a first sensing magnet groove 1258A, and an adhesive is set on the first sensing magnet groove 1258A and/or the first sensing magnet 1283; B2, insert the first sensing magnet 1283 into the first sensing magnet groove 1258A along a direction parallel to the second axis X. The insertion stroke of the first sensing magnet 1283 into the first sensing magnet groove 1258A along this direction is short, and the first sensing magnet 1283 can be accommodated and protected by the first sensing magnet groove 1258A. In the present application, the adhesive may be specifically a UV thermosetting adhesive, and step B also comprises a step B3: UV light irradiation is used to cure the UV thermosetting adhesive set in step B1, so that the first sensing magnet 1283 is pre-fixed in the first sensing magnet groove 1258A. It is worth mentioning that UV thermosetting glue is a type of glue that can be cured by UV light (ultraviolet light) or baking.

In some embodiments, the first sensing magnet groove 1258A has a first inclined limiting surface 12581 and a second inclined limiting surface 12582, the first inclined limiting surface 12581 is arranged on a side away from the second rotation magnet 1263, and the second inclined limiting surface 12582 is arranged on a side away from the first rotation sensing element 1281, the first inclined limiting surface 12581 and the second inclined limiting surface 12582 can be arranged perpendicular to each other, and are respectively suitable for abutting against two adjacent side surfaces of the first sensing magnet 1283, so that the first sensing magnet 1283 is installed obliquely in the first sensing magnet groove 1258A. The inclination angle of the first sensing magnet 1283 can be determined by the two inclined limiting surfaces, reducing the difficulty of assembly.

In some embodiments, in the step B1, an adhesive can be preset on the side of the first sensing magnet 1283 that is away from the second rotation magnet 1263 and the adjacent side which is away from the first rotation sensing element 1281, and the first sensing magnet 1283 can be positioned in a direction perpendicular to the third axis Z with the help of the first inclined mounting surface 12581 and the second inclined mounting surface 12582, and maintain an inclined or flat posture. Further, the first sensing magnet 1283 can also be positioned in a direction parallel to the third axis Z with the help of the two oppositely disposed side walls of the first sensing magnet groove 1258A in a direction parallel to the third axis Z. In other embodiments, the adhesive can also be preset on the first inclined mounting surface 12581, the second inclined mounting surface 12582, the two oppositely disposed side walls of the first sensing magnet groove 1258A in a direction parallel to the third axis Z, and the two oppositely disposed side surfaces of the first sensing magnet 1283 in a direction parallel to the third axis Z. It is worth mentioning that the first sensing magnet 1283 is inserted into the first sensing magnet groove 1258A along a direction parallel to the second axis X.

In some embodiments, the step B further comprises a step B4 performed after the step B3: providing an adhesive between the first sensing magnet 1283 and the spacer plate 1259 and curing the adhesive, which is beneficial to increase the connection strength of the first sensing magnet 1283.

In some embodiments, one side of the carrier 125 is recessed inward to form a first sensing magnet groove 1258A and a rotation magnet groove 1255, and two first rotation magnets 1261 and one second rotation magnet 1263 are centrally fixed in the rotation magnet groove 1255.

In some embodiments, a step D is carried out between the step B and the step C: providing two first rotation magnets 1261 suitable for driving the carrier 125 to rotate around the first axis Y, installing the two first rotation magnets 1261 on the carrier 125 at intervals, and installing them on the same side of the carrier 125 as the first sensing magnet 1283, so that when the second rotation magnet 1263 is installed on the carrier 125 in the step C, the second rotation magnet 1263 can be installed between the two first rotation magnets 1261. Specifically, the two first rotation magnets 1261 can be positioned and installed first by using the rotation magnet groove 1255, and then the second rotation magnet 1263 can be positioned and installed by relying on the two first rotation magnets 1261 on both sides, which is conducive to the precise installation of each magnet.

In some embodiments, the step D may specifically comprise the following steps: D1, the carrier 125 is recessed inward on the side where the first sensing magnet groove 1258A is provided to form a rotation magnet groove 1255 adjacent to the first sensing magnet groove 1258A, and two first rotation magnets 1261 suitable for driving the carrier 125 to rotate around the first axis Y are provided; D2, an adhesive is provided in the rotation magnet groove 1255 and/or on the first rotation magnet 1261; D3, along a direction parallel to the first axis Y, the first rotation magnet 1261 is inserted into the rotation magnet groove 1255 from the side of the rotation magnet groove 1255 away from the first sensing magnet groove 1258A; D4, the adhesive provided in the step D2 is cured.

As a supplement, since there are two first rotation magnets 1261, the two first rotation magnets 1261 can be installed in batches. Specifically, a round of the steps D2 to D4 can be performed first so that one of the first rotation magnets 1261 is pre-fixed in the rotation magnet groove 1255, and then a second round of the steps D2 to D4 can be performed so that the other first rotation magnet 1261 is pre-fixed in the rotation magnet groove 1255, so that the two first rotation magnets 1261 are installed on the carrier 125 at intervals. Alternatively, the installation of the two first rotation magnets 1261 is completed at one time. Specifically, when performing the step D2, adhesives are respectively set in the installation areas of the two first rotation magnets 1261, and when performing the step D3, the two first rotation magnets 1261 are inserted into the rotation magnet groove 1255 synchronously or successively, and when performing the step D4, the adhesives at the two first rotation magnets 1261 are cured.

Furthermore, considering that the magnetic poles of the two first rotation magnets 1261 on the adjacent side are the same, there is a magnetic repulsion between the two first rotation magnets 1261. If the two first rotation magnets 1261 are inserted into the rotation magnet groove 1255 synchronously, a clamp needs to be set to maintain the spacing between the two first rotation magnets 1261, and a space for the clamp to move needs to be reserved on the carrier 125. When the size of the carrier 125 on the side where the rotation magnet groove 1255 is located remains unchanged, setting a movable space for the clamp will occupy the installation space of the first rotation magnet 1261, resulting in the size of the first rotation magnet 1261 needing to be reduced, affecting the driving effect of the first rotation magnet 1261. The method of inserting the two first rotation magnets 1261 into the rotation magnet groove 1255 in a direction parallel to the first axis Y successively can rely on the groove wall of the rotation magnet groove 1255 to provide the first rotation magnet 1261 with a supporting force to overcome the magnetic repulsion, and there is no need to reserve additional space to set the clamp.

As a supplement, in the step D2, adhesives can be set at two installation areas of the bottom of the rotation magnet groove 1255 that are spaced apart along the direction parallel to the third axis Z, and in order to avoid the adhesive overflow in this step from affecting the installation of the second rotation magnet 1263 in the step C, the adhesive should be set at the bottom of the rotation magnet groove 1255 at a position away from the installation area of the second rotation magnet 1263 during dispensing in the step D2. In other embodiments, in the step D2, the adhesive can also be set at two opposite sides of the rotation magnet groove 1255 in the direction parallel to the third axis Z, one side of the rotation magnet groove 1255 close to the first sensing magnet groove 1258A, one side of the two first rotation magnets 1261 away from each other, one side of the two first rotation magnets 1261 opposite to the bottom of the rotation magnet groove 1255, and one side of the two first rotation magnets 1261 close to the first sensing magnet groove 1258A in the direction parallel to the first axis Y.

In some embodiments, the step C specifically comprises the following steps: C1, set an adhesive in the rotation magnet groove 1255 and/or on the second rotation magnet 1263; C2, insert the second rotation magnet 1263 into the rotation magnet groove 1255 from the side of the rotation magnet groove 1255 away from the first sensing magnet groove 1258A along a direction parallel to the first axis Y; C3, cure the adhesive set in the step C1, so that the second rotation magnet 1263 is pre-fixed on the carrier 125, and is arranged opposite to the first sensing magnet 1283 along a direction perpendicular to the third axis Z.

In some embodiments, in the step C1 and the step D2, the reflection magnetic conductive sheet 1265 can be partially exposed to the rotation magnet groove 1255, or in other words, the reflection magnetic conductive sheet 1265 can constitute at least a partial groove bottom of the rotation magnet groove 1255, so that an adhesive can be provided on the reflection magnetic conductive sheet 1265, and the adhesive can be more tightly bonded to the reflection magnetic conductive sheet 1265 made of metal material, which is beneficial to increase the strength of the bonding structure.

In some embodiments, the magnetic pole of the second rotation magnet 1263 facing the first sensing magnet 1283 is opposite to the magnetic pole of the first sensing magnet 1283 facing the second rotation magnet 1263, so that the two magnets can be easily disposed adjacent to each other.

It should be particularly pointed out that the side of the second rotation magnet 1263 facing the first sensing magnet 1283 may have a single magnetic pole or may have two or more magnetic poles. For example, the side of the second rotation magnet 1263 facing the first sensing magnet 1283 and close to the first rotation sensing element 1281 is an N pole, and the side of the second rotation magnet 1263 facing the first sensing magnet 1283 and away from the first rotation sensing element 1281 is an S pole. Correspondingly, the side of the first sensing magnet 1283 facing the second rotation magnet 1263 and close to the first rotation sensing element 1281 is an S pole, and the side of the first sensing magnet 1283 facing the second rotation magnet 1263 and away from the first rotation sensing element 1281 is an N pole. Similarly, the first rotation magnet 1261 may be provided with a single magnetic pole or two or more magnetic poles in a direction parallel to the second axis.

In some embodiments, the magnetic pole of the second rotation magnet 1263 facing the first sensing magnet 1283 is the same as the magnetic pole of the first rotation magnet 1261 on both sides facing the second rotation magnet 1263, and the magnetic pole of the second rotation magnet 1263 facing away from the first sensing magnet 1283 is opposite to the magnetic pole of the first rotation magnet 1261 on both sides facing the second rotation magnet 1263. Assuming that the magnetic pole of the second rotation magnet 1263 facing away from the first sensing magnet 1283 is the same as the magnetic pole of the first rotation magnet 1261 on both sides facing the second rotation magnet 1263, and the magnetic pole of the second rotation magnet 1263 facing the first sensing magnet 1283 is opposite to the magnetic pole of the first rotation magnet 1261 on both sides facing the second rotation magnet 1263, then when the step C2 is initially executed, the magnetic pole of the second rotation magnet 1263 facing the first sensing magnet 1283 is opposite to the magnetic pole of the first rotation magnet 1261 on both sides facing the second rotation magnet 1263. There is magnetic attraction between the adjacent first rotation magnets 1261 on both sides, but as the distance of the second rotation magnet 1263 inserted into the rotation magnet groove 1255 along the direction parallel to the first axis Y increases, a magnetic repulsion is generated between the side of the second rotation magnet 1263 away from the first sensing magnet 1283 and the adjacent first rotation magnets 1261 on both sides, and a magnetic repulsion is applied to the second rotation magnet 1263 to move away from the first sensing magnet 1283, causing the second rotation magnet 1263 to deviate from the preset position. The magnetic pole of the second rotation magnet 1263 facing the first sensing magnet 1283 is the same as the magnetic pole of the first rotation magnet 1261 on both sides facing the second rotation magnet 1263, and the magnetic pole of the second rotation magnet 1263 facing away from the first sensing magnet 1283 is opposite to the magnetic pole of the first rotation magnet 1261 on both sides facing the second rotation magnet 1263. When the second rotation magnet 1263 is inserted into the rotation magnet groove 1255 along the direction parallel to the first axis Y and the distance is small, it is subjected to magnetic repulsion. At this time, the magnet assembling equipment can apply a supporting force sufficient to overcome the magnetic repulsion to the second rotation magnet 1263. When the second rotation magnet 1263 is inserted into the preset position of the rotation magnet groove 1255, the side of the second rotation magnet 1263 that is away from the first sensing magnet 1283 generates a magnetic attraction force with the first rotation magnets 1261 adjacent to both sides, so that after the magnet assembly equipment is removed, the two first rotation magnets 1261 have little influence on maintaining the second rotation magnet 1263 in the preset position.

It can be understood that in the above steps C2 and D3, the rotation magnets are inserted into the rotation magnet groove 1255 from the side of the rotation magnet groove 1255 away from the first sensing magnet groove 1258A in the direction parallel to the first axis Y. Such an installation method means that the magnet assembling equipment only needs to locate the installation position of the rotation magnet in the direction parallel to the third axis Z, and then push the rotation magnet into the rotation magnet groove 1255 in the position parallel to the direction of the first axis Y, and push the rotation magnet to abut against the slot wall of the rotation magnet groove 1255 close to the first sensing magnet groove 1258A in the direction parallel to the first axis Y. And the position of the first rotation magnet 1261 in the direction parallel to the third axis Z can be determined by the two oppositely arranged groove walls of the rotation magnet groove 1255 in the direction parallel to the third axis Z, and the position of the second rotation magnet 1263 in the direction parallel to the third axis Z can be determined by the two first rotation magnets 1261. If the rotations magnets are inserted in a direction parallel to the second axis X, the magnet assembly device needs to confirm the installation position of the rotation magnets in a direction parallel to the first axis Y and in a direction parallel to the third axis Z. In particular, if the second rotation magnet 1263 is inserted in a direction parallel to the second axis X when executing the step C2, the two opposite sides of the second rotation magnet 1263 close to and away from the first sensing magnet groove 1258A respectively generate magnetic attraction and magnetic repulsion with the first rotation magnet 1261, and the magnet assembly device also needs to provide support for the second rotation magnet 1263 to prevent the second rotation magnet 1263 from tilting.

Therefore, in some embodiments of the present application, the assembling direction of the first rotation magnet 1261 and the second rotation magnet 1263 is perpendicular to the assembling direction of the first sensing magnet 1283, so that the assembling accuracy of the first rotation magnet 1261, the second rotation magnet 1263, and the first sensing magnet 1283 can be guaranteed.

In some embodiments, the first sensing magnet groove 1258A and the rotation magnet groove 1255 are arranged adjacent to each other, and the above mentioned spacer plate 1259 is arranged therebetween. In order to prevent the second rotation magnet 1263 from squeezing the spacer plate 1259 during assembly and thus affecting the first sensing magnet 1283 on the other side of the spacer plate 1259, a gap is arranged between the second rotation magnet 1263 and the spacer plate 1259.

In some embodiments, a surface of the spacer plate 1259 facing the first sensing magnet 1283 is configured to be flat to facilitate demolding of the carrier 125.

In some embodiments, the magnet assembling method of the reflection drive assembly also comprises a step E: provide a second sensing magnet 1284 suitable for detecting the rotation angle of the carrier 125 around the first axis Y, and install the second sensing magnet 1284 on the carrier 125. Specifically, the step E may comprise the following steps: E1, one side of the carrier 125 is recessed inward to form a second sensing magnet groove 1258B, and an adhesive is provided in the second sensing magnet groove 1258B and/or on the second sensing magnet 1284; E2, insert the second sensing magnet 1284 into the second sensing magnet groove 1258B along a direction parallel to the third axis Z. The insertion stroke of the second sensing magnet 1284 into the second sensing magnet groove 1258B along this direction is short, and the second sensing magnet 1284 can be accommodated and protected by the second sensing magnet groove 1258B. It also comprises a step E3: cure the adhesive provided in the step E1, so that the second sensing magnet 1284 is pre-fixed in the second sensing magnet groove 1258B. Similar to the first sensing magnet 1283, the second sensing magnet 1284 is smaller than other magnets, and the installation position is easily affected by other magnets. However, in the present application, the second sensing magnet 1284 and other magnets can be arranged on different sides of the carrier 125 to reduce the influence of other magnets on the installation process of the second sensing magnet 1284. Then the step E can be performed after any other step, or before other steps except the step A and the step B, so as to further reduce the influence of other large magnets during the assembly process. There is no requirement for the execution order between the step B and the step E.

In some embodiments, the magnet assembling method of the reflection drive assembly also comprises a step F: install a magnetic magnet 12711 on the carrier 125. The magnetic magnet 12711 can be set to two, and are spaced apart on both sides of the carrier base 12511 of the carrier 125 along a direction parallel to the third axis Z. The step F can specifically comprise the following steps: F1, the carrier 125 is recessed inward along the direction of the first axis Y toward one side of the reflection base 121 to form a magnetic magnet groove, and two magnetic magnets 12711 suitable for mutual magnetic attraction with the second reflection magnetic member 1272 on the reflection base 121 are provided; F2, an adhesive is set on the magnetic magnet groove and/or the magnetic magnet 12711; F3, the magnetic magnet 12711 is inserted into the magnetic magnet groove along a direction parallel to the first axis Y; F4, the adhesive set in the step F2 is cured. In addition, the two magnetic magnets 12711 can be installed in batches. Specifically, a round of the steps F2 to F4 may be performed first so that one of the magnetic magnets 12711 is pre-fixed in the magnetic magnet groove, and then a second round of the steps F2 to F4 may be performed so that the other magnetic magnet 12711 is pre-fixed in the magnetic magnet groove. Alternatively, the installation of two magnetic magnets 12711 may be completed at one time. Specifically, when performing the step F2, adhesives is respectively set in the installation areas of the two magnetic magnets 12711, and when performing the step F3, the two magnetic magnets 12711 are inserted synchronously or successively into the corresponding magnetic magnet grooves, and when performing the step F4, the adhesives at the two magnetic magnets 12711 is cured.

In some embodiments, the step A, the step B, the step E, the step F, the step D, and the step C are performed sequentially to reduce the influence of other magnets on the installation process of the sensing magnet, and to use the two first rotation magnets 1261 for positioning when installing the second rotation magnet 1263.

In the steps B to F, the adhesive can be UV thermosetting adhesive, and the preliminary curing of the UV thermosetting adhesive can be achieved by ultraviolet light irradiation in the steps B3, B4, C3, D4, E3, and F4. Furthermore, considering that it is difficult for ultraviolet light to irradiate the back of each magnet, the carrier 125 assembled with all the magnets can be baked in the last step of the magnet assembling method of the reflection drive assembly to completely cure the UV thermosetting adhesive to improve the connection strength and improve the structural stability. Of course, the possibility of baking the carrier 125 in the steps B to E to cure the UV thermosetting adhesive at different positions is not ruled out.

It should be understood that in order to improve the reliability of fixing each magnet on the carrier 125, a glue filling step can also be added before or after the final baking step. Specifically, the adhesive can be supplemented around the first sensing magnet 1283, the second sensing magnet 1284, and the magnetic magnet 12711, or on the side of the two first rotation magnets 1261 and the second rotation magnet 1263 away from the first sensing magnet 1283, and then the supplemented glue is cured by ultraviolet light irradiation or baking. It is worth mentioning that in some embodiments, the glue used to fix the magnet to the carrier 125 does not protrude from the carrier 125, thereby reducing the risk of the rotation of the carrier 125 being affected by the setting of the glue.

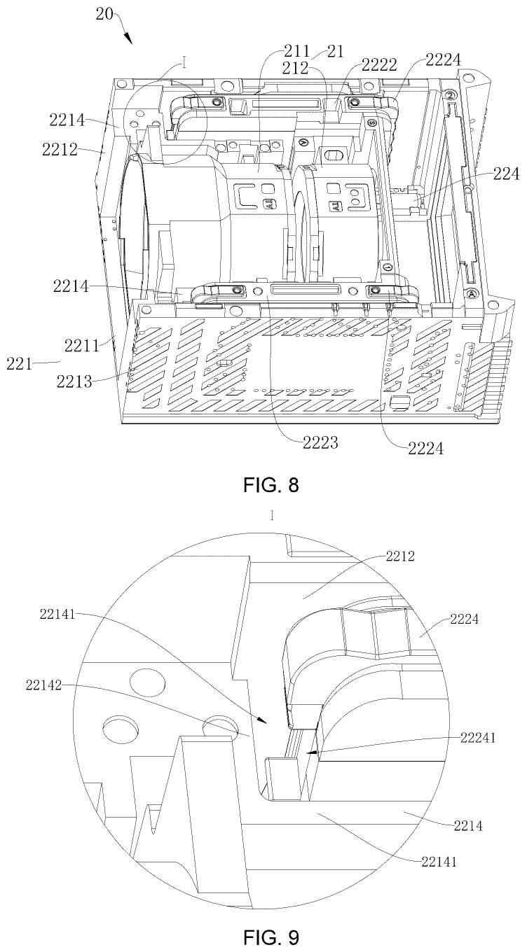

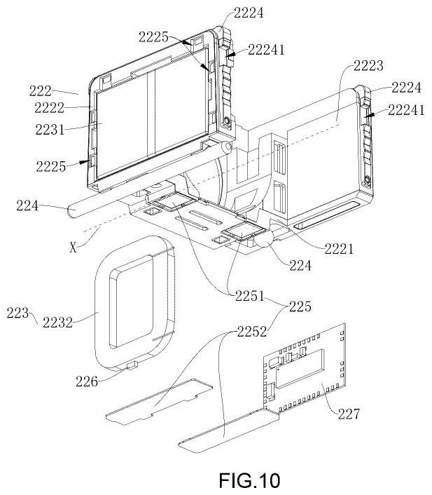

In some embodiments, as shown in FIGS. 2 and 8-10, the lens assembly 20 comprises an optical lens 21 and a lens driving assembly 22. The optical lens 21 comprises an optical lens whose optical axis is arranged along the second axis X to converge light. The lens driving assembly 22 is used to drive the optical lens 21 to move to achieve optical image stabilization, focusing and other functions.

In some embodiments, the lens driving assembly 22 comprises a lens base 221, a fixed group mounting portion 2214 fixedly disposed on the lens base 221, and a movable group support holder 222 movably disposed on the lens base 221. The fixed group mounting portion 2214 and the movable group support holder 222 are both suitable for supporting the optical lens 21, and the optical lens 21 comprises a fixed group 211 mounted on the fixed group mounting portion 2214, and a movable group 212 mounted on the movable group support holder 222, and the fixed group 211 and the movable group 212 each comprise at least one optical lens element. The optical lens elements in the fixed group 211 are fixedly disposed with respect to the lens base 221, and the optical lens elements in the movable group 212 are able to move with respect to the lens base 221 following the movable group support holder 222, so as to achieve optical image stabilization, focusing, and the like.

In some embodiments, the lens base 221 comprises a lens base body 2211, two lens base side portions arranged opposite to each other in a direction parallel to the third axis Z, and a lens cover 228. The lens base body 2211 cooperates with the two lens base side portions to form an optical lens accommodating cavity suitable for installing the optical lens 21, and the lens cover 228 is arranged with respect to the lens base body 2211 in a direction parallel to the first axis so that the optical lens accommodating cavity is relatively closed. For ease of description, the two lens base side portions are respectively recorded as a first lens base side portion 2212 and a second lens base side portion 2213. Specifically, the first lens base side portion 2212, the second lens base side portion 2213 and the fixed group mounting portion 2214 can all be formed by extending upward from the lens base body 2211 as a whole. Correspondingly, the movable group support holder 222 comprises a support holder main body 2221, a first support holder side portion 2222 corresponding to the first lens base side portion 2212, and a second support holder side portion 2223 corresponding to the second lens base side portion 2213. The fixed group mounting portion 2214 also comprises two side portions that are arranged opposite to each other in a direction parallel to the third axis Z.

In some embodiments, the lens base 221 and the reflection base 121 are split structures or an integrated structure, and the lens cover body 228 and the reflection cover body 129 are split structures or an integrated structure. The integrated structure is conducive to reducing assembling steps.

In some embodiments, slide grooves 22141 suitable for the movable group support holder 222 to slide along the direction of the second axis X are formed between the fixed group mounting portion 2214 and the side portion of the lens base, and a limiting protrusion 22142 is located at the end of each slide groove 22141. The first support holder side portion 2222 and the second support holder side portion 2223 are respectively suitable for sliding along the slide grooves 22141 on two sides and abutting against the limiting protrusion 22142 to achieve the focus (AF) function. The limiting protrusion 22142 can be specifically arranged at one end of each slide groove 22141 relatively close to the reflection assembly 10, and the limiting protrusion 22142 extends in a direction parallel to the third axis Z to define the end of the travel of the support holder side portion sliding in the direction close to the reflection assembly 10.

In some embodiments, a support holder buffer element 2224 is provided on the movable group support holder 222, and the support holder buffer element 2224 is made of a flexible material, such as silicone. The support holder buffer element 2224 can be set on the side of the support holder by gluing, secondary injection molding, etc. The support holder buffer element 2224 can be provided on the two sides of the movable group support holder 222 that is relatively arranged in a direction parallel to the third axis Z. Specifically, one support holder buffer element 2224 can be provided on each of the two sides of the support holder, or one support holder buffer element 2224 can extend to the two sides of the support holder. The support holder buffer element 2224 protrudes with respect to the corresponding side of the support holder in at least one direction to buffer the corresponding side of the support holder during the sliding process of the movable group support holder 222.

In some embodiments, the support holder buffer element 2224 protrudes upward in a direction parallel to the first axis Y to provide buffering when the movable group support holder 222 accidentally collides with the lens cover body 228, and/or the support holder buffer element 2224 protrudes downward in a direction parallel to the first axis Y to provide buffering when the movable group support holder 222 accidentally collides with the lens base body 2211, and/or the support holder buffer element 2224 protrudes in a direction parallel to the second axis X toward the direction close to the reflection assembly 10 to provide buffering when the movable group support holder 222 accidentally collides with the limiting protrusion 22142 on the lens base 221, and/or the support holder buffer element 2224 protrudes in a direction parallel to the second axis X toward the direction away from the reflection assembly 10 to provide buffering when the movable group support holder 222 accidentally collides with the lens base 221.

In some embodiments, the support holder buffer element 2224 protrudes in a direction parallel to the first axis with respect to the limiting protrusion 22142, and an avoidance groove 22241 corresponding to the edge of the limiting protrusion 22142 is provided on the support holder buffer element 2224. In other words, the height of the top of the support holder buffer element 2224 is higher than the height of the top of the limiting protrusion 22142. In order to prevent the support holder buffer element 2224 from being cut by the edge of the top of the limiting protrusion 22142 during the sliding of the bearing seat side in the direction parallel to the second axis X, the avoidance groove 22241 is provided at the position of the support holder buffer element 2224 corresponding to the area of the top of the limiting protrusion 22142.

In some embodiments, the side of the support holder is provided with an opening 2225 or a groove opened in a direction parallel to the third axis Z. When the support holder buffer element 2224 is formed by injection molding, it can enter the opening 2225 or the groove to form an undercut structure with the side of the support seat to increase the bonding strength. Specifically, the movable group support holder 222 can be first injection molded with plastic, and then the support holder buffer element 2224 can be formed by secondary injection molding with silicone.

In some embodiments, the lens assembly 20 further comprises a lens driving unit 223, and the lens driving unit 223 comprises a focus magnet 2231 and a focus coil 2232. The focus coil 2232 can be specifically arranged in the focus coil slot of the first lens base side portion 2212, and the focus magnet 2231 can be arranged on the first support holder side portion 2222 to be arranged opposite to the focus coil 2232. When the focus coil 2232 is energized, a magnetic field can be generated and act on the focus magnet 2231, thereby driving the movable group support holder 222 to move.

In some embodiments, the lens assembly 20 further comprises a lens support portion 224 disposed between the movable group support holder 222 and the lens base body 2211, which is used to support the movable group support holder 222, limit the sliding direction of the movable group support holder 222, and reduce the friction resistance when the movable group support holder 222 slides. Specifically, the lens support portions 224 are disposed on two opposite sides of the movable group support holder 222 along a direction parallel to the third axis Z, and each lens support portion 224 is specifically a guide rod and/or a focus ball, and the movable group support holder 222 and the lens base body 2211 are provided with corresponding guide rod tracks and focus ball grooves.

In some embodiments, the lens support portion 224 comprises a guide rod and a ball roller which are arranged relatively parallel to the third axis Z direction. The guide rod and the lens driving unit 223 are arranged on the same side of the lens assembly 20, and the ball roller is arranged on a side relatively far away from the lens driving unit 223. Specifically, one ball roller can be provided. Compared with the ball roller, the contact area between the guide rod and the movable group support holder 222 and the lens base body 2211 is larger, and the friction resistance force on the movable group support holder 222 is greater. Therefore, the guide rod is arranged on a side relatively close to the lens driving unit 223, which can reduce the risk of the movable group support holder 222 tilting due to the different friction resistance forces on both sides.

In some embodiments, the lens assembly 20 further comprises a lens magnetic attraction part 225. The lens magnetic attraction part 225 comprises a first lens magnetic component 2251 and a second lens magnetic component 2252. The first lens magnetic component 2251 and the second lens magnetic component 2252 are arranged opposite to each other, and one of the two is arranged on the movable group support holder 222, and the other is arranged on the lens base body 2211. The two generate a mutual magnetic attraction force, so that the movable group support holder 222 can be movably supported on the lens base 221 through the lens support portion 224.

In some embodiments, the lens assembly 20 further comprises a focus position sensing unit for sensing the position of the movable group support holder 222, so as to facilitate closed-loop control. Specifically, the focus position sensing unit comprises a focus position sensing element 226 and the above mentioned focus magnet 2231, and the focus position sensing element 226 is arranged on the lens base 221 with respect to the focus magnet 2231. More specifically, the focus position sensing element 226 is arranged below the focus coil 2232 with respect to the edge of the focus magnet 2231.

In some embodiments, the lens driving assembly 22 integrates a drive chip unit 227. The drive chip unit 227 is electrically connected to the reflection drive part 126, the rotation position sensing part 128, the lens driving unit 223, and the focus position sensing unit at the same time to uniformly control and centrally manage each part. Specifically, the drive chip unit 227 comprises a drive chip circuit board and a drive chip mounted on the circuit board. The drive chip unit 227 and the lens drive unit 223 are arranged on two opposite sides of the lens base 221 along a direction parallel to the third axis, that is, one of them is arranged on the first lens base side portion 2212, and the other is arranged on the second lens base side portion 2213. The two are staggered and the layout is more reasonable.

In some embodiments, the reflection base 121 and/or the lens base 221 are also embedded with conductive inserts to facilitate electrical connection of the driving chip unit 227, the reflection drive part 126, the rotation position sensing part 128 and other parts.

In some embodiments, the image assembly 30 comprises a photosensitive component 31 for generating an image according to the imaging light. Further, the image assembly 30 also comprises a filter component 32 for filtering stray light in the imaging light to improve the imaging quality.

The above describes the basic principles, main features and advantages of the present application. Those skilled in the art should understand that the present application is not limited to the above embodiments. The above embodiments and the specification only describe the principles of the present application. The present application may have various changes and improvements without departing from the spirit and scope of the present application. These changes and improvements fall within the scope of the present application for which protection is sought. The scope of protection claimed by the present application is defined by the attached claims and their equivalents.

1. A reflection drive assembly, comprising:
a reflection base;
a carrier which is rotatably disposed on said reflection base for carrying a reflection element, wherein the reflection element is arranged to reflect light propagating in a direction parallel to a first axis to propagate in a direction parallel to a second axis;
a reflection drive part comprising a second rotation magnet and a second rotation coil arranged opposite to each other, wherein said second rotation magnet and said second rotation coil are arranged to cooperate to drive said carrier to rotate with respect to said reflection base around a third axis, wherein the third axis is perpendicular to the first axis and the second axis; and
a rotation position sensing part comprising a first sensing magnet and a first rotation sensing element arranged to detect a rotation angle of said carrier around the third axis, wherein said first sensing magnet and said second rotation magnet are arranged opposite to each other in a direction perpendicular to the third axis, wherein said first rotation sensing element is arranged to simultaneously sense magnetic fields of said first sensing magnet and said second rotation magnet.

2. The reflection drive assembly according to claim 1, wherein a projection of the first rotation sensing element along a perpendicular direction from a side thereof facing said second rotation magnet overlaps with said first sensing magnet and said second rotation magnet.

3. The reflection drive assembly according to claim 1, wherein said second rotation magnet and said second rotation coil are arranged opposite to each other in a direction parallel to the second axis, said first sensing magnet and said second rotation magnet are arranged opposite to each other in a direction parallel to the first axis, and said first rotation sensing element is arranged opposite to both of said first sensing magnet and said second rotation magnet in a direction parallel to the second axis.

4. The reflection drive assembly according to claim 3, wherein when projected along a direction parallel to the second axis, a projection of said second rotation magnet and a projection of said second rotation coil both overlap with the first axis, said first rotation sensing element is arranged on one side of said second rotation coil along a direction parallel to the first axis, and said first sensing magnet is arranged on one side of said second rotation magnet along a direction parallel to the first axis.

5. The reflection drive assembly according to claim 1, wherein said first rotation sensing element is disposed on an outer side of said second rotation coil.

6. The reflection drive assembly according to claim 5, wherein said reflection drive part also comprises a first rotation magnet and a first rotation coil, said first rotation magnet and said first rotation coil are arranged to cooperate to drive said carrier to rotate around the first axis with respect to said reflection base, said first rotation coil and said second rotation coil are located on a same side of said reflection drive part in a direction perpendicular to the third axis, and said first rotation sensing element is arranged on an outer side of said first rotation coil.

7. The reflection drive assembly according to claim 1, wherein magnetic poles of said first sensing magnet and said second rotation magnet facing each other are opposite.

8. The reflection drive assembly according to claim 7, further comprising a spacer plate disposed between said first sensing magnet and said second rotation magnet.

9. The reflection drive assembly according to claim 1, wherein a side of said first sensing magnet away from said second rotation magnet is inclined toward a direction approaching or away from said first rotation sensing element.

10. The reflection drive assembly according to claim 9, wherein an inclination angle of said first sensing magnet is not greater than 45°.

11. The reflection drive assembly according to claim 9, wherein an extension distance of a side of said first sensing magnet facing said first rotation sensing element and away from said second rotation magnet along a direction perpendicular to the third axis is not more than 1.2 mm, and an extension distance of a side of said first sensing magnet facing said second rotation magnet along a direction perpendicular to the third axis is not less than 0.4 mm.

12. The reflection drive assembly according to claim 9, wherein along a direction in which said first sensing magnet and said second rotation magnet are arranged with respect to each other, said first sensing magnet is closer to said first rotation sensing element than said second rotation magnet.

13. The reflection drive assembly according to claim 9, wherein said carrier is provided with a first sensing magnet groove, wherein a first inclined limit surface and a second inclined limit surface which are arranged perpendicular to each other are arranged around said first sensing magnet groove for abutting against two adjacent side surfaces of said first sensing magnet, so as to inclinedly install said first sensing magnet in said first sensing magnet groove.

14. The reflection drive assembly according to claim 9, wherein said first sensing magnet and said second rotation magnet are mounted on said carrier, and a reflection magnetic conductive sheet is disposed on said carrier, wherein said reflection magnetic conductive sheet, which is arranged at a position avoiding said first sensing magnet, is disposed opposite to said second rotation magnet.

15. The reflection drive assembly according to claim 1, wherein said rotation position sensing part further comprises a second rotation sensing element and a second sensing magnet which are arranged opposite to each other to cooperate for detecting a rotation angle of said carrier around the first axis.

16.-20. (canceled)
